(19) United States
(12) Patent Application Publication
(10) Pub. No.: US 2005/0273416 A1
(43) Pub. Date: Dec. 8, 2005

(54) Method and system for conducting an auction

(76) Inventor: Richard Warren Tanzer, Neenah, WI (US)

Correspondence Address: RICHARD W. TANZER, 413 BEAULIEU RD, NEENAH, WI, 54956, US

(21) Appl. No.: 10/851,622

(22) Filed: May 22, 2004

(51) Int. Cl. G06F 17/60

(52) U.S. Cl. 705/37

(57) ABSTRACT

A method and system for conducting a auctions. A method of conducting an auction is disclosed which involves specifying an item for sale; identifying at least two potential bidders; generating a bidder's array for each potential bidder, each bidder's array comprising at least one value; a bidder making at least one bid for the item, each bid comprising a value; and identifying values of bids, that within a specified range, match values in the bidders' arrays. Computer-based methods of conducting an auction of this type are also presented. A system for conducting an auction is taught which includes an item for sale; potential bidders; a bidder's array for each potential bidder, each bidder's array having at least one value; a bidder; a bid; and matched values, which are values of selected bids that are within a specified range of values in the bidders' arrays. Certain aspects of the invention also provide for auctions of this type that include granting prizes.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### DETAILED DESCRIPTION OF THE INVENTION

While traditionally a natural person or persons, the “auctioneer” may in this context, also may be a central computer or a distributed computer system that provides the functions of a traditional auctioneer. These functions may include announcing the rules of the auction including establishing a winning criterion or criteria, the opening of bidding, time keeping, identifying bidders, receiving bids, verifying bids, announcing and tracking bids, awarding prizes, receiving payments, identifying the winning bid, and delivering products or services. The function of the auctioneer may be entirely done by a natural person, or partially or fully automated. The auctioneer function may be done in one central location or dispersed among a plurality of locations.

In certain embodiments of this invention, the auctioneer may be the owner of an item being auctioned; alternatively the auctioneer may be an intermediary, working for the owner. In other embodiments of this invention, the auctioneer may be the purchaser of an item or represent the purchaser of an item.

The auctioneer establishes rules of the auction. The rules may dictate a reserve price, duration of the auction, specifics of the bidding system (English, Vickrey, silent, reverse, Dutch, etc.), when bidders have an opportunity to inspect the items, and so forth. The rules of the auction may also define how a bidder qualifies for a reward.

An “item” for sale, may be a tangible item such as a book, a computer, or a painting. Alternatively, an item may be a service such as lawn maintenance, tuning a piano, or legal services. An item for sale may also be intangible, such as the use of power transmission lines, access to communications channels, docking or landing rights, patent rights, rights to use land for a particular purpose, an investment bond, or options to purchase a financial instrument as a specified price.

In any auction a bidder only becomes an actual bidder when their first bid is offered. In this disclosure, the term “potential bidder” is used to describe those persons, businesses, or other parties that are likely or qualified to bid in the auction. In an open bidding face-to-face auction, the potential bidders may simply be those individuals present at the beginning of an auction. In other embodiments of this invention potential bidders may consist of individuals present in person, and/or represented by proxy, and/or those individuals not physically present, but in communication with the auctioneer by conventional mail, messenger, telephone, radio, carrier pigeon, or digital communication means such as e-mail, via an internet computer connection, a networked computer system, or various combinations of these methods, or other means. In some embodiments of the invention, potential bidders are all the members of an organization, or all persons residing in a defined area.

In some embodiments of the invention, potential bidders must be identified prior to the beginning of bidding. Identification as a bidder may require registration, using a real name or an alias. Registration may take place in person, by conventional mail, telephone, e-mail, via an internet computer connection, a networked computer system, facsimile or various combinations of these methods, or other means. One option is to register on the computer web site of the auctioneer. Registration may or may not require payment of some sort from the potential bidder to the auctioneer. In some scenarios, the potential bidders registration payment is in the form of purchase of a catalogue or an entry fee or a ticket of some sort. Alternatively, in order to register, potential bidders may need to provide an indication of ability to pay, in the form of submitting credit card, establishing an account with the auctioneer, or other means.

In some embodiments of this invention, bidders are first identified and registered when they actually place their first bid. An auction is a competition; so more than one potential bidder is required for an auction to take place. In some embodiments of this invention at least 4 potential bidders must be registered before the auction begins. In other embodiments of this invention at least 10 potential bidders must be registered before the auction begins. In some embodiments of this invention no more than 1000 potential bidders may participate in the auction. Alternatively, no more than 100 potential bidders may participate in the auction. In certain embodiments of the invention the number of potential bidders is limited to no more than 20.

As used herein, an “array of values” or simply an “array” is one number or a set of numbers corresponding to particular values. Generally, values are dollar values. In other embodiments of this invention, the values may correspond to other fungible assets, such as ounces of gold, or barrels of oil.

In some embodiments of this invention, a “master array” is a set of values from which values are drawn to produce “bidders' arrays.” In various embodiments of this invention, the master array may be held secret by the auctioneer; in other embodiments the master array may be public. Public disclosure of the master array may be prior to, during, or after bidding.

Additionally, in some embodiments, a bidder's array may be publicly disclosed prior to the opening of bidding. Alternatively a bidder's array may be private, known only by that particular bidder; or known only by that particular bidder and the auctioneer; or kept secret and only revealed after the close of bidding.

The general formula for the number of possible combinations (nCr) of n objects taken r at a time is: nCr =n!/r!(n−r)!. For various embodiments of this invention, nCr represents the number of possible unique bidders' arrays of size r (without regard to the sequence of the values in each bidder's array) from a master array with n distinct values.

Depending upon how the bidders' arrays are used, it may be useful to determine the number of permutations of n objects taken r at a time which is equal to n factorial divided by n minus r factorial, or nPr=n!/(n−r)!. nPr represents the number of possible unique bidders' arrays of size r (considering the sequence of the values in each bidders array) from a master array with n distinct values.

Alternatively, arrays are based on pre-existing values associated with individual characteristics of the bidder, for example various digits from the bidders' age, birth date, driver's license, height, license plate numbers, membership numbers, postal codes, social security number, telephone numbers street addresses, or weight may be used to construct arrays.

In yet other embodiments bidders may choose their own arrays.

While there may be any positive whole number of values in either a master array or in a bidder's array, in some embodiments no more than 121 discrete values are in an array. In other embodiments no more than 60 values constitute an array. In still other embodiments no more than 25 values are in an array, and in yet other embodiments there may be no more than 4 values in an array.

A bidder's array may simply be a single number. Alternatively, a bidders array may be a list of numbers. In other embodiments of this invention, a bidders array may be in the form of a puzzle. One form of a puzzle is a bingo card format, i.e. a 5×5 array of numbers with a “free” space in the center box. Other puzzle formats include three-dimensional objects. An example of a three dimensional puzzle is a sheet of cardboard scored to facilitate its folding into a cube, and printed with an array such that when the cardboard is folded into a cube shape, the outside surface of the cube exhibits six values.

Any of these lists or puzzle representations may be either in physical form, or a drawing, represented on a computer display, or reside on a computer data base.

In an open bidding face-to-face auction, the potential bidders may be those individuals present at the beginning of an auction. Providing bidders' arrays to actual or potential bidders, may consist of the auctioneer delivering a physical list, such as a bingo card to the bidders. In some situations the list may be delivered by a proxy representing the auctioneer, for example a retail store clerk may distribute bidders' arrays.

If some potential bidders are not physically present at the auction, their lists of values may be provided to them by the auctioneer using conventional mail, telephone, e-mail, via an internet computer connection, a networked computer system, facsimile, telegraph, radio broadcast, or various combinations of these methods, or by other means.

In some embodiments of this invention it may be difficult to define an actual location for the auction. For example, the auction may be conducted using a distributed system of computers, or the auction may take place in several locations in communication by telephone or other means.

Regardless of how the bidders receive their arrays, they are said to be “provided” with their arrays.

For the purpose of this disclosure, a useful definition of an auction is a method of buying and selling an item or items wherein the price of the item is determined by competition among potential buyers or competition among potential sellers. Many auctions have a single seller and a plurality of potential buyers, i.e. bidders; these are referred to as “single seller” auctions. Other auctions have a single buyer and a plurality of potential sellers, i.e. bidders; these are referred to as “single buyer” auctions.

Communications among the parties involved in the auction, including bidding, may take place in person, by conventional mail, telephone, e-mail, via an internet computer, on a networked computer system, by facsimile, semaphore signals, carrier pigeon message or various combinations of these methods, or other means.

In a single seller auction the seller wishes to sell the item for the maximum price available from a qualified buyer in an appropriate time frame. The selling price is the result of potential buyers competing against each other to buy the item.

In various embodiments of this invention, the auction techniques listed below may be used singularly, or in various combinations:
“English” auctions. An English auction is a single seller auction. Bidding begins with either the first offered price from a bidder or a “reserve” price. (The reserve price is the minimum acceptable bid for the item.) The auctioneer solicits successively higher bids until no one will increase the bid. The item is sold to the highest bidder. One variation of the English auction includes the element of time; bidders have only a limited time to place the next bid. Typically English auctions are “open,” that is, other actual or potential bidders may learn the value of other bid in real time. Alternatively, auctions may be “sealed” or “silent” that is, bids may kept secret until some specified time.
“Vickrey” auctions. A variation on the English auction, wherein the item is sold to the highest bidder at the second-highest amount bid.
“Dutch,” or descending-price auctions. These are open auctions wherein the auctioneer announces very high opening bid. The auctioneer progressively lowers the bid until demand rises to match supply.

In a single buyer auction the buyer wishes to buy the specified item for the minimum price available from a qualified seller. The selling price is the result of potential sellers competing against each other, i.e. bidding, to sell the item. A common example of a single buyer auction is a government accepting bids for a service; bidding takes place among the businesses wishing to provide the service.

In some circumstances it is important to distinguish an individual auction event, and a series of auctions. An “auction event” is a series of bids for a particular item, or bundle of items, sold for a price based on that particular series of bids. In contrast, a “series of auctions” indicates that at least two series of bids are held and at least two items, or bundles of items, are sold. For example, a total of four paintings are sold in a series of auctions; the series consists of four auction events, wherein one painting is sold at each auction event.

As used herein, a “minimum bid increment” is the least increase or decrease in successive bids acceptable to the auctioneer, that is, the minimum spacing between bids. For example in an English auction, if the rules of the auction set a minimum bid increment as $10, and the most recent bid was $70, the auctioneer will not accept any subsequent bid less than $80. Certain forms of auctions may have minimum bid increments, other forms of auctions may permit a specified number of identical bids, and yet other auctions may entirely dispense with the concept of a minimum bid increment. In still further embodiments the minimum bid increment is calculated on a percentage basis.

Bids are selected for comparison with the bidders' arrays. In some embodiments of this invention the rules of the auction specify which bids will be selected for comparison purposes. Alternatively, the rules of the auction may declare that a random drawing is used to determine which bid or bids are selected for comparison with the bidders' arrays. In other embodiments of this invention, all bids are selected for comparison with the bidders' arrays.

In some embodiments of this invention only the last bid is selected for comparison with the bidders' arrays. In other embodiments of the invention the next-to-last bid is compared to the values in each bidder's array. In still other embodiments the first bid, the second bid, or the first bid of over a certain value, or the first bid made after a certain elapsed time following the opening bid is compared with the values in the bidders arrays.

In certain embodiments of this invention the winning bid (i.e. the bid that results in the bidder being sold the item) is also a selected bid. Alternatively, the winning bid is not a selected bid.

The value of each selected bid is compared to the values in each bidder's array. When the value of a selected bid is equal to a value in a bidders array, that value in the array is identified as a match. Alternatively, if the value of a selected bid is within a specified range, for example +/−10% or +/−$1, of a valued in a bidder's array, that value in the array is identified as a match. Identifying a value in a bidder's array as a match may be recorded by physically marking a card or a puzzle in some manner, alternatively recording a match may consist of an making an entry in an electronic database. The rules of the auction specify if an exact match of a bid with a value in a bidder's array is required, or if it suffices that the bid matches a value to be within a specified range.

The rules of the auction specify certain prize criteria. The prize criteria define the number of matched values or a particular pattern of matched values which earn the bidder a prize. A bidder's array is said to “satisfy” a prize criterion when the number of matched values or a particular pattern of matched values in the array meet the requirements of the criterion.

In some embodiments of this invention, having a single matched value is sufficient to earn a prize. In other embodiments several matched values are necessary to qualify for an award.

In certain examples of this invention, the first bidder or bidders to accumulate the specified number of matched values qualifies for a prize. In other examples of this invention, a certain pattern or sequence of matched values is necessary to qualify for a reward.

For example, considering bidders' arrays in the form of a bingo card, one particular mode of using a bingo card is to require that five values, in the form of either a vertical line, a horizontal line, or a diagonal line on the bingo card, be matched with bids to earn a prize for the bidder. In this particular mode of using a bingo card format, the sequence of the values printed on the card is likely to be significant. Alternatively, a certain number of matches, regardless of their position on the bingo card may be required.

In some embodiments of this invention, prizes are based on a single auction event. Alternatively, bidders may retain their arrays over the course of a defined or an open-ended series of auctions and accumulate matched values in that array. In further embodiments bidders use one particular array for one particular auction event, but the number of matches may be accumulated by bidders during a series of auctions to earn prizes.

### EXAMPLE I

A city wishes to have a water tower built. The city publishes its intention to accept bids for construction of the water tower built to certain specifications. The specifications are available for public inspection, and bidders have 90 days to submit sealed bids. The city identifies six qualified bidders.

The city engineer estimates that the cost of the water tower project will be in the $900,000 to $1,100,000 range. The auctioneer, working for the city, generates a master array of {$850,000, $860,000, $870,000, $880,000, $890,000, and $900,000}. The master array is publicly known. Each bidder's array, in the form of printed cards, consists of one of these values.

The bidders come to city hall, and each bidder draws his or her array at random. Only the bidder knows which array he or she has chosen.

The rules of the auction ordain that the lowest bidder will receive the contract; and if the lowest bidder's bid is equal to that bidder's array, then that bidder will receive a 10% bonus as a reward. In this example, the lowest bidder bid $870,000. That bidder also had the array consisting of {$870,000}, therefore the low bidder is actually paid $957,000 for the water tower contract.

In this example the objective of this auction system is to encourage bidders to bid a lower value than they might otherwise bid. This auction is an example of a single buyer auction.

### EXAMPLE II

An auction is organized to sell decorative table lamps. During the past month similar lamps have sold for $200, $175, $320, $210, and $360 in similar auctions. The auctioneer calculates the median value as $210. The auctioneer uses a computer program to generate random values between half of the median value ($105) and twice the median value ($420). In this auction the minimum incremental bid is set at $5. The random values are rounded to integral multiples of a minimum bid increment. These rounded values constitute the master array.

Various combinations of 24 values are selected from the master array to create bidders' arrays. In this example each bidder's array is unique. The bidders' arrays are presented in the form of “bingo cards.” A sufficient number of bingo cards are generated to provide one for each potential bidder.

One particular bingo card is shown in Table 1. In this example the values are entered in increasing order column by column; the values could be ordered in any suitable manner.

TABLE 1
example of “bingo card”

| | | | | |
|---|---|---|---|---|
| $115 | $195 | $260 | $310 | $340 |
| $125 | $210 | $265 | $315 | $345 |
| $130 | $235 | FREE | $325 | $350 |
| $140 | $240 | $280 | $330 | $400 |
| $145 | $245 | $285 | $335 | $415 |

This is an open bidding, face-to-face English auction, the potential bidders are those individuals present at the beginning of an auction. Each person present receives a bidder's array in the form of a bingo card. The highest bidder wins the auction event and purchases the table lamp at the highest value bid. The value of the high bid is compared to the values in each bidder's array. High bids equal in value to a value in a bidders array constitute a match. The match value in the array is highlighted on the bingo card.

Over the course of a series of auctions, additional matches are made and the appropriate boxes on the bingo cards, i.e. values in bidders' arrays, are highlighted. The first person to complete (i.e. completely highlight) a vertical line, a horizontal line, or a diagonal line on the bingo card, receives a $100 credit towards a purchase. If more than one individual completes a line at the end of the same auction event, then the reward is evenly split among the winners.

### EXAMPLE III

A diamond auction is simultaneously conducted in five cities. The locations are in continuous communication by satellite television and internet computer connection to a central server computer. A series of auctions consisting of 24 separate auction events is held. The entire series of auctions take place in 24 hours, each auction lasts for 1 hour.

The diamonds are sold in lots. Each lot has an estimated value of $1,000,000 to $3,000,000. The reserve price for each lot is $750,000 and the minimum incremental bid is $10,000.

Potential bidders are required register for the auction and must be approved prior to the opening of the series of auctions. Potential bidders may select 10 values, these values represent their bidder's array. In this example, there is no predefined master array. Each bidder's array is known only to the auctioneer and that particular bidder.

The first bidder to match four values in his or her array with selected bids receives a $250,000 credit towards any purchase in the series of auctions. The second bidder to match four values in his or her array with selected bids receives a $100,000 credit towards any purchase in that series of auctions. In the event that more than one bidder matches four values at the same auction event, the credit is shared accordingly.

This auction is conducted as a “Vickrey” auction, i.e. the high bidder for auction event purchases the lot of diamonds at the second-highest amount bid. Matched values in the bidders' arrays are based on the highest bid, not the actual sale price. For example, in one auction event bidding for a lot of diamonds consists of the following bids in this order: $900,000 (by Aviva), $950,000 (by Mike), $1,320,000 (by Beth), $1,500,000 (by Mike), $1,550,000 (by David), and $1,570,000 (by Rachel). Rachel “wins” this auction event, i.e. buys the lot of diamonds, for $1,550,000.

All actual or potential bidders with the value $1,570,000 in their array have a match. In this series of auctions the matching function is done by the auctioneer by making appropriate entries in the database in the central server computer.

The high bid of $1,570,000 is the fourth matched value in Aviva's array. She is the first bidder to have four matched values, she therefore receives a $250,000 credit towards her purchase.

### EXAMPLE IV

One hundred (100) automobiles are being sold at auction. The auctioneer generates a master array in the following manner.
Determine a reference, or typical price for the items being sold. (Pstd).
Calculate 0.80Pstd, 0.82Pstd, 0.84Pstd, . . . 1.36Pstd, 1.38Pstd, and 1.40Pstd.
These 31 values are rounded to the nearest $10 and then used as the master array.
All possible combinations of 5 values selected from the master array are used to generate bidders' arrays. In this example 169,911 unique bidders' arrays are generated.

Prior to this series of auctions, bidders' arrays are offered for sale at $5 each. Potential bidders must purchase at least one array, but may purchase as many arrays as they wish. Over a series of auctions, the first person to match all five values in one of their arrays with the high bid for auction events may select any of the remaining available cars at no cost. Provisions are made for simultaneous winners to share a prize.

The auction is conducted as an English auction. However, rather than use the typical open call format, all potential bidders are loaned wireless communication devices, such as computers which are in communication with the auctioneer's computer. In this way the potential bidders can inspect the automobiles as the auction proceeds. The auctioneer keeps track of which bidders have purchased which arrays, and which values are matched with values in bidders arrays at any particular time.

### EXAMPLE V

As a charity fundraiser, a series of English auctions are conducted through an internet provider of auction services. The charity is auctioning the personal services of members of the charitable organization. The items being auctioned include tax accounting services, roof repair, and chiropractic services. In this auction the three highest bids serve to are compared to values in the bidders' arrays to identify matches. The internet provider of auction services receives a fee for accounting for the matched values in the bidders' arrays and identifying which bidders have satisfied the prize criteria, and other services such as informing the bidders of their reward and crediting their accounts.

### EXAMPLE VI

In this example, one hundred (100) municipal bonds are being auctioned to raise funds for a city. The bonds pay $200 per year for 9 years and at the end of 10 years pay $10,200. The auctioneer, employed by the city, provides arrays consisting of three values to each qualified potential bidder.

In this auction, as bids are received by the city they are published on the city's web site. 217 bids are received by the city via their internet web site. The bids, listed in order of decreasing value are:
bid(1)=$10,103, bid(2)=$10,101, . . . , bid(101)=$10,000, bid(100)=$9,998, bid(99)=$9,997, . . . ,bid(216)=$9,500, bid(217)=$9,500

A server computer, owned and operated by a contractor working for the city is in communication with the city's web site. The computer records the data for each bidder, comprising name, address, telephone number, account number, number of bids and the value of each bid, identification of any land parcels within the city owned by the bidder, and the values in the bidder's array. At the close of the auction the computer rank-orders the bids, and the city publishes the bids and the bidders' arrays, highlighting matched values. The 100 highest bids are accepted by the city and sold for the price offered by the 100^{th} highest bid, $9998.

Only actual bidders, not potential bidders who do not bid, are eligible to qualify for a prize. The rules of the auction include criteria requiring that all the values in a bidder's array must be matched with bids for the bidder to receive a prize. One particular bidder, Marleen has an consisting of {$10,850, $10,350, and $9,990}. When reviewing the bids on-line, Marleen's observes that bids of $10,350, and $9,990 have already been recorded. Marleen bids $10,850, giving her three matched values. Having satisfied the criteria, she receives a prize consisting of a real estate tax discount.

### EXAMPLE VII

At a county fair, each entry ticket has a unique six-digit number (herein represented as a b c d e f). A series of English auctions are held at a county fair. The bidders' arrays are {a b, c d, e f}. The last bid in each auction event is selected for comparison with values in the bidders' arrays. In this auction only the last two digits of the selected bid are compared with the values in the bidders' arrays for matching purposes. For example, in the first four auction events items sell for $128, $67, $222, and $91, respectively. Ticket holder, i.e. potential bidder, Walter has ticket number 226791; Vivian has ticket number 226792; Carl has ticket number 239167; and Mary has ticket 239168. In this auction it is not necessary that the potential bidder actually bid to qualify for a prize. Walter is the first potential bidder to match all three values in his array {22, 67, 91}; his prize is $50 in the form of a voucher to be used at the fair.

### EXAMPLE VIII

Coins are auctioned. The coins are shown and described on television. Based on reference materials, the value of each lot of coins being auctioned is estimated to be in the $1000 to $10,000 range.

In this set of auctions potential bidders must pre-register with proof of ability to pay. A credit card with sufficient credit balance is accepted as proof of ability to pay. At the time of registration, bidders may select their array of values. In this example a bidder's array consists of 9 values arranged in a 3×3 matrix. The bidders inform the auctioneer of their choice for their array.

Potential bidders may submit their bids by telephone, e-mail, or through the internet web site of the auctioneer. A series of twelve Vickrey auctions are conducted wherein the highest bidder obtains the item at the bid presented by the second highest bidder.

In each auction a value in a bidders' array is matched if it corresponds to the high bid (last bid); additionally a value in a bidders' array is matched if it corresponds to the value of the winning bid (next to highest bid). The auctioneer, using a spreadsheet program operating on personal computer, matches bids with values in the bidders' arrays as the bids are made. A line (vertical, horizontal, or diagonal) in the 3×3 matrix with matched values satisfies the prize criterion. Also, the first bidder to match all 9 values in their array receives an additional prize. In this example, the bidders retain their arrays over the course of the series of auctions and accumulate matched values in that array.

After noting the first occurrence of a bidder's array in which includes a line of matched values, the auctioneer credits that bidder's account with an award. Subsequently, after noting the first occurrence of a bidder's array in which all nine values are matched values, the auctioneer credits that bidder's account with an award.

The rules of the auction allow for split prizes in the event that a plurality of bidders qualify for an award following the same auction event.

### EXAMPLE IX

In this embodiment of the invention a charitable organization distributes cards with scratch-off areas. These cards constitute the bidders' arrays. Each area is visibly inscribed with a dollar value, hidden under certain scratch-off areas are inscriptions, which when revealed, indicate that the auction criteria have been satisfied and the cardholder has won a prize.

Information providing security and/or identification of the cardholder may also be carried on the card in such forms as an encrypted code, a bar code, a radio frequency identification tag, or a magnetic strip

1. A method of conducting an auction comprising:
specifying an item for sale;
identifying at least two potential bidders;
providing a bidder's array to each potential bidder, each bidder's array comprising at least one value;
a bidder making at least one bid for the item, each bid comprising a value; and
identifying values of bids, that within a specified range, match values in the bidders' arrays.

2. The method of claim 1, further comprising comparing the matched values to prize criteria.

3. The method of claim 2, further comprising awarding prizes to bidders whose arrays satisfy the prize criteria.

4. The method of claim 2, further comprising potential bidders purchasing their bidders' arrays.

5. The method of claim 2, wherein matched values comprise values of bids that are equal to values in the bidders' arrays.

6. The method of claim 5, further comprising awarding prizes to bidders whose arrays satisfy the prize criteria.

7. A system for conducting an auction comprising:
an item for sale;
at least two potential bidders;
a bidder's array for each potential bidder, each bidder's array comprising at least one value;
a bidder, comprising a potential bidder that actually submits a bid;
a bid comprising a value made by a bidder for the item and
matched values, comprising values of selected bids that are within a specified range of values in the bidders' arrays.

8. The system of claim 7, wherein the matched values comprise values of selected bids that are equal to values in the bidders' arrays.

9. The system of claim 8, further comprising prize criteria.

10. The system of claim 9, further comprising an auctioneer, wherein at least some of the functions of the auctioneer are conducted by a computer.

11. The system of claim 9, wherein the bidder's array is in the form of a printed card.

12. The system of claim 9, wherein the selected bids are the final bid, the next-to-final bid, or both of the last two bids.

13. The system of claim 9, wherein the selected bids are neither the first bid nor the second bid.

14. A method of conducting an auction comprising:
specifying an item for sale;
identifying at least two potential bidders;
providing a bidder's array to each potential bidder, each bidder's array comprising at least one value;
a bidder making at least one bid for the item, each bid comprising a value;
selecting at least one bid for comparison with the bidders' arrays; and
identifying values of selected bids, that within a specified range, match values in the bidders' arrays.

15. The method of claim 14, further comprising:
specifying a prize criterion;
comparing the matched values to the prize criterion;
satisfying the prize criterion.

16. The method of claim 15, further comprising a second bidder making a second bid higher in value than the first bid.

17. The method of claim 15, further comprising a second bidder making a second bid lower in value than the first bid.

18. The auction of claim 15, wherein the selected bid is the final bid.

19. The auction of claim 15, wherein the selected bid is the bid immediately preceding the final bid.

20. The auction of claim 15, wherein the selected bid is neither the first bid nor the second bid.

21. The auction of claim 15, wherein the bidder's array is in the form of a printed card or puzzle.

22. A method of conducting an auction comprising:
specifying an item for sale;
establishing at least one prize criterion;
providing a bidder's array to each bidder, each bidder's array comprising at least one value;
at least one bidder making at least one bid for the item, each bid comprising a value;
selecting at least one bid for comparison with the bidders' arrays;
identifying values of bids that match values in the bidders' arrays; and
awarding prizes to the bidder or bidders whose arrays comprise values that match a prize criterion.

23. The method of claim 22, further comprising conducting at least some of the functions of the auctioneer using a computer.

24. The method of claim 23, further comprising generating a master array, wherein the master array is used to provide bidders' arrays.

25. The method of claim 23, wherein the selected bid is the final bid, the next-to-final bid, or both of the last two bids.

26. The method of claim 23, further comprising entering the bidder's array is in a computer database.

27. The method of claim 23, further comprising printing the bidder's array on card or puzzle.

28. The method of claim 27, further comprising purchasing, by the bidder, a printed bidder's array.

29. A system for conducting an auction comprising:
an auctioneer;
an item for sale;
a plurality of potential bidders;
a bidder's array for each potential bidder, each bidder's array comprising at least one value;
at least one bid for the item, each bid comprising a value;
at least one selected bid for comparison with the bidders' arrays;
values of bids that match values in the bidders' arrays; and
at least one prize criterion specified by the auctioneer.

30. The system of claim 29, wherein the selected bid is either the final bid or the next-to-final bid.

31. The system of claim 29, wherein the selected bid is neither the first bid nor the second bid.

32. The system of claim 29, wherein the bidder's array is in the form of a printed card or puzzle.

33. The system of claim 29, wherein the bidder's array is selected by the bidder.

34. The system of claim 29, wherein the bidder's array is determined by selecting digits from specified pre-existing values associated with individual characteristics of the bidder,

35. The system of claim 29, wherein the bidder's array is provided by the auctioneer.

36. The system of claim 29, further comprising a computer with a database to provide at least some of the functions of the auctioneer.

37. The system of claim 29, further comprising a master array wherein the bidder's array is a subset of the master array.

38. A method of conducting a series of auctions comprising:
conducting a plurality of auction events, wherein each auction event comprises:
specifying an item for sale;
identifying at least two potential bidders;
providing a bidder's array to each potential bidder, each bidder's array comprising at least one value;
a bidder making at least one bid for the item, each bid comprising a value;
selecting at least one bid for comparison with the bidders' arrays; and
identifying values of bids that match values in the bidders' arrays.

39. The method of claim 38, further comprising:
accumulating matched values from a plurality of auction events;
specifying at least one prize criterion;
comparing the number of matched values to prize criteria; and
awarding prizes to a bidder or potential bidder whose matched values satisfy at least one prize criterion.

40. The method of claim 39, wherein the selected bid is either the final bid or the next-to-final bid.

41. The method of claim 39, wherein the selected bid is neither the first bid nor the second bid.

42. A system for conducting a series of auctions comprising a plurality of auctions, each auction comprising:
an auctioneer;
an item for sale;
a plurality of potential bidders;
a bidder's array for each potential bidder, each bidder's array comprising at least one value;
at least one bid for the item, each bid comprising a value;
at least one selected bid for comparison with the bidders' arrays;
matched values, corresponding to values of selected bids that match values in the bidders' arrays;
at least on prize criterion specified by the auctioneer.
an accumulation of matched values for at least one bidder, said accumulation comprising matched values from a plurality of auction events; and
prizes, awarded to a bidder or potential bidder whose accumulation of matched values satisfy at least one prize criterion.

43. The system of claim 42, wherein bidders are in direct verbal or visual communication with the auctioneer.

44. The system of claim 42, further comprising:
at least one computer with a database to provide at least some of the functions of the auctioneer; and wherein the bidders communicate with the auctioneer using digital communication means.
